(19) United States
(12) Patent Application Publication
(10) Pub. No.: US 2010/0256964 A1
(43) Pub. Date: Oct. 7, 2010

(54) SYSTEM AND TECHNIQUE TO QUANTIFY A FRACTURE SYSTEM

(75) Inventors: Donald W. Lee, Houston, TX (US); Jose Ignacio Adachi, Houston, TX (US); Lennert David den Boer, Calgary (CA); Joel Herve Le Calvez, Farmers Branch, TX (US)

Correspondence Address: SCHLUMBERGER INFORMATION SOLUTIONS, 5599 SAN FELIPE, SUITE 1700, HOUSTON, TX, 77056-2722, US

(73) Assignee: Schlumberger Technology Corporation, Houston, TX (US)

(21) Appl. No.: 12/419,799

(22) Filed: Apr. 7, 2009

(51) Int. Cl. G06G 7/48

(52) U.S. Cl. 703/10

(57) ABSTRACT

A technique includes generating a fracture network model to characterize a fracture system in a reservoir that is associated with a well. The generation of the model includes constraining the model based at least in part on identified naturally occurring fractures and microseismic measurements that were acquired during a fracturing operation that was conducted in the well.

### BACKGROUND

The invention generally relates to a system and technique to quantify a fracture system, such as a fracture system that includes hydraulically induced fractures and naturally occurring fractures.

For purposes of producing a hydrocarbon (oil or natural gas) from a subterranean reservoir, a well is first created by drilling a wellbore into the reservoir to provide a flow path to communicate the hydrocarbon to the surface. Operations may subsequently be conducted for purposes of enhancing the productivity of the well.

For example, hydraulic fracturing enhances the productivity of the well by forcing the formation rock, or strata, to crack, or fracture. A typical hydraulic fracturing operation involves injecting a fracturing fluid into the wellbore and applying pressure on the fluid to force the fracturing fluid against the formation strata. The resulting forces typically create new fractures in the formation as well as extend existing naturally occurring fractures. The fracturing fluid may contain proppant, which is a material that enters the fractures and prevents the fractures from closing when the pressure is removed at the conclusion of the hydraulic fracturing operation.

It has traditionally been difficult to quantify the system of fractures that results from the fracturing operation. Thus, challenges currently exist in accurately assessing the effectiveness of the fracturing operation and estimating the productivity of the well after the fracturing operation.

### SUMMARY

In an embodiment of the invention, a technique includes generating a fracture network model to characterize a fracture system in a reservoir that is associated with a well. The generation of the model includes constraining the model based at least in part on identified naturally occurring fractures and microseismic measurements that were acquired during a fracturing operation that was conducted in the well.

In another embodiment of the invention, a system includes an interface to receive first data that identify naturally occurring fractures in a reservoir that is associated with a well and second data that indicate microseismic measurements that were acquired during a fracturing operation that was conducted in the well. The system includes a processor to generate a fracture network model to characterize a fracture system of the reservoir. The processor constrains the model based at least in part on the first and second data.

In yet another embodiment of the invention, an article includes a computer readable storage medium that stores instructions that when executed cause a computer to receive first data, which identify naturally occurring fractures in a reservoir that is associated with a well and receive second data, which are indicative of microseismic measurements that were acquired during a fracturing operation that was conducted in the well. The instructions when executed cause the computer to generate a fracture network model to characterize a fracture system in the reservoir and constrain the model based at least in part on the first and second data.

Advantages and other features of the invention will become apparent from the following drawing, description and claims.

### BRIEF DESCRIPTION OF THE DRAWING

FIG. 1 is a schematic diagram of a well after a fracturing operation according to an embodiment of the invention.

FIG. 2 is a flow diagram depicting a technique to generate a discrete fracture network (DFN) model according to an embodiment of the invention.

FIG. 3 is a flow diagram depicting a technique to quantify a fracture system according to an embodiment of the invention.

FIG. 4 is a schematic diagram of a processing system according to an embodiment of the invention.

### DETAILED DESCRIPTION

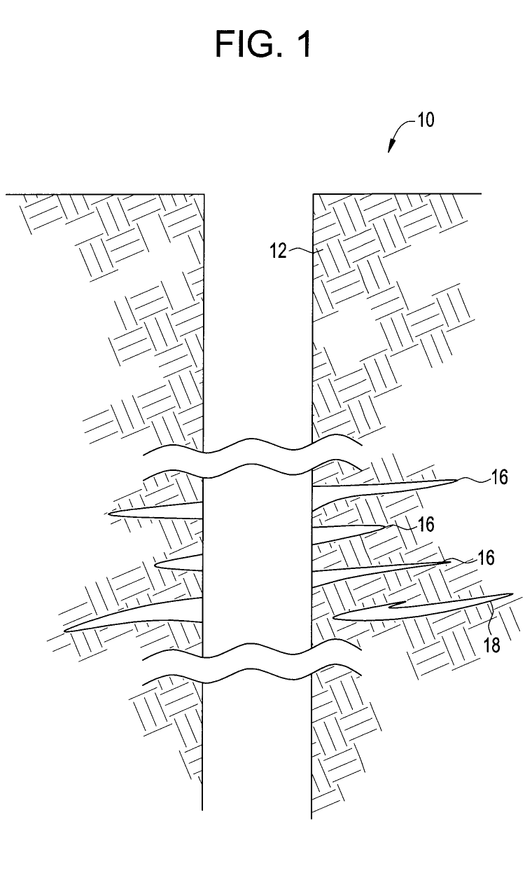

FIG. 1 depicts a well 10, which includes a wellbore 12 that extends into a hydrocarbon producing reservoir. For purposes of enhancing its productivity, the well 10 has been subjected to a fracturing operation, an operation in which pressurized fracturing fluid was used to induce the opening and/or extension of existing naturally occurring fractures 18, as well as the creation of new hydraulically induced fractures 16. As a more specific example, in accordance with embodiments of the invention, the reservoir is a relative low permeability reservoir (such as a nano darcy permeability reservoir, for example), whose productivity is enhanced by the fracturing operation.

In accordance with embodiments of the invention described herein, a discrete fracture network (DFN) model is generated for purposes of quantifying the resulting fracture system after the fracturing operation and quantifying the anticipated production from the well 10. In general, the DFN model indicates the locations, orientations, widths, heights, lengths, etc. of fractures in the fracture system.

Quantification of the induced fracture system is complex and is dependent upon such factors as rock properties, formation stress, pore pressure and, in some cases, pre-existing naturally occurring fractures. More specifically, if naturally occurring fractures exist, these fractures interact with the hydraulically induced fractures, which contribute to the complexity of the resulting fracture system and complicates the evaluation of the effectiveness of the hydraulic fracturing operation. For purposes of developing an accurate representation of the fracturing system, various measurements of the reservoir, which are taken before, during and slightly after the fracturing operation are combined and used to constrain the DFN model. As described herein, these measurements and parameters that are derived from these measurements are used to constrain the fracture properties and the location and extent of the fractures, which are indicated by the DFN.

In accordance with some embodiments of the invention, at least three different types of measurements are used to constrain the DFN: seismic survey measurements, microseismic measurements and borehole survey measurements.

The borehole and seismic surveys are acquired before the fracturing operation, and the microseismic measurements are acquired during and slightly after the fracturing operation. The seismic measurements may be conducted at the surface of the well 10 or downhole in the wellbore 12 by activating a seismic source (an impulse source or a vibroseis source, as non-limiting examples) and then measuring the resulting seismic response by hydrophones or geophones, which may be disposed at the surface of the well, in the wellbore 12 or in an observation wellbore (as non-limiting examples). It is noted that the seismic measurements are indicative of the general locations and general orientations of the naturally occurring fracture clusters, or swarms. Although the seismic survey provides a relatively coarse approximation of the existence and density of the natural fracture system, the seismic survey permits observation of the naturally occurring fracture system from a region near the wellbore 12 (the near field) into a region relatively far away from the wellbore 12 (the far field).

The borehole survey measurements may be acquired by one or more borehole surveys. In each of these surveys, a borehole-disposed tool is run into the wellbore 12 on a conveyance device, such as a tubing, wireline, slick line, etc. As examples, the borehole survey tool may be a formation micro imager tool, a sonic scanning tool, etc. The data collected by the borehole survey tool may be processed to produce a relatively higher resolution image of the near field naturally occurring fracture system, as compared to the image that is derived from the seismic survey data. Although the depth of the investigation of the borehole survey is limited, the seismic measurements that are obtained through the seismic survey may be integrated with the borehole survey-derived measurements to provide a calibrated indication of the naturally occurring fracture system. Thus, the seismic and borehole measurements may be used in conjunction to identify the existence and location of naturally occurring fractures close to and away from the wellbore 12.

After the above-described borehole and seismic surveys have been conducted, the fracturing operation is conducted in the wellbore 12 to further open the existing naturally occurring fractures 18 and to create new fractures 16. Both of these occurrences generate microseismic events, which may be observed during and slightly after the fracturing operation.

More specifically, during the fracturing operation, the opening of existing naturally occurring fractures and the creation of new fractures generate microseismic events, which may be detected by triaxial sensors (geophones, for example), which may be disposed in an observation well (as a non-limiting example). The location, timing and source parameters of microseismic events may be monitored during and soon after the completion of the hydraulic fracturing operations. The microseismic measurements yield such source parameters as the local magnitude, the moment magnitude, etc. Additionally, the acquired microseismic measurements may be used to determine the focal mechanism, which allows the determination of the failure mechanism of the formation rock. In this regard, using the microseismic measurements such techniques as full waveform inversion or moment tensor inversion may be used for purposes of visualizing the failure modes under which the microseismic events are generated.

Identifying the various failure modes allows differentiation between open mode and shear mode events, and such differentiation allows the discrimination between the reopening of naturally occurring fractures and the creation of new fractures. Furthermore, the information gained by the microseismic measurements provides checks on the naturally occurring fractures that are identified by the above-described surveys.

In accordance with embodiments of the invention described herein, the location and timing of the microseismic events (derived from the microseismic measurements) are used to constrain the construction of the DFN model. More specifically, the above-described identified naturally occurring fractures (in the microseismic zone) and the microseismic measurements are used to constrain the extent and the density of the combined naturally occurring and hydraulically-induced fracture system that is indicated by the DFN model.

More specifically, the density and volume attributes of the DFN model are constrained in view of the observed microseismic events. Seismic estimated naturally occurring fractures are included if located within the microseismic event zone. It is noted that the fracture orientations and densities that are derived from the seismic measurements may be different from the orientations and densities that are indicated by the microseismic measurements.

The DFN may be further constrained based on rock properties of the reservoir, in accordance with embodiments of the invention. More specifically, the DFN may be constrained using a two-dimensional (2-D) or three-dimensional (3-D) mechanical earth model (MEM). In this regard, the MEM may be constructed for the reservoir for purposes of evaluating the rock mechanical and stress properties of the reservoir near the wellbore 12. Depending on the particular embodiment of the invention, the MEM may be constructed based on borehole survey measurements and/or seismic measurements of the reservoir.

The MEM indicates such Earth stresses as the pore pressure, stress tensor, stress tensor directions and magnitudes, rock mechanics properties (Young's modulus and Poisson's ratio, unconfined compressive strength (UCS), internal friction angle, etc.). The MEM along with the microseismic measurement-derived hypocentral locii and associated source parameters are used to constrain the fracture properties of the DFN model. As examples, these properties may include the widths and heights of the fractures; and the information that is provided by the MEM may be used to determine which set of fractures are likely to be open or closed.

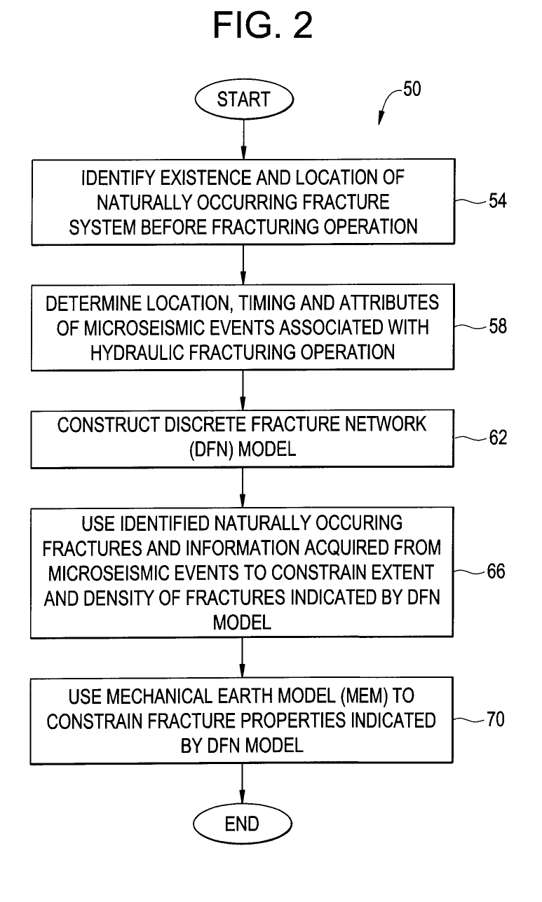

Referring to FIG. 2, thus, in accordance with embodiments of the invention, a technique 50 for generating a DFN model includes identifying (block 54) the existence and location of a naturally occurring fracture system before a fracturing operation occurs. The technique includes determining the location, timing and attributes of microseismic events that are associated with a hydraulic fracturing operation, pursuant to block 58. Based on this information, the technique 50 includes constructing (block 62) a discrete fracture network (DFN) model. The identified naturally occurring fractures and the information that is acquired from the microseismic measurements are used, pursuant to block 66, to constrain the extent and density of the fracture clusters that are indicated by the DFN model. Additionally, a mechanical earth model (MEM) is used, pursuant to block 70 to constrain the fracture properties, which are indicated by the DFN model and also for purposes of determining which fractures are open or closed.

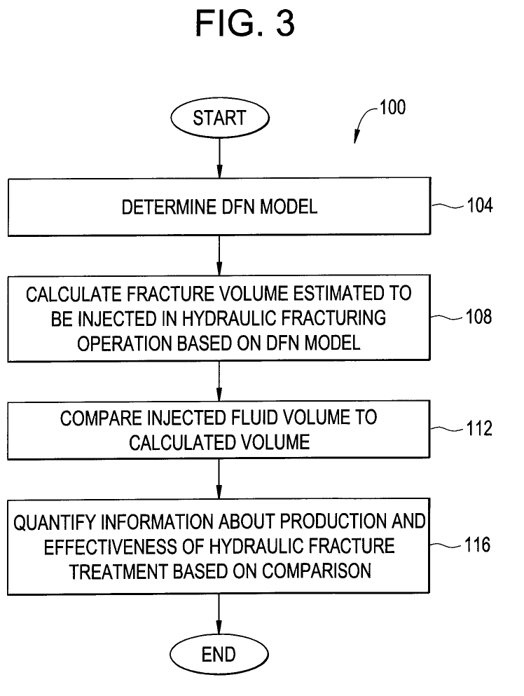

The DFN model may be used to improve the understanding of hydrocarbon production from the well 10 as well as may be used to evaluate the effectiveness of the hydraulic fracture treatment. More specifically, in a technique 100 that is depicted in FIG. 3, a DFN model is determined, pursuant to block 104 and the volume of fracture fluid that is estimated to be injected during a fracturing operation is calculated based on the DFN model, pursuant to block 108. The calculated volume is compared to the actual injected fluid volume (block 112), and this comparison is used to quantify (block 116) information about the production and quantify the effectiveness of the hydraulic fracture treatment. For example, if the calculated and actual volumes do not agree, then various assumptions may be made about the fracture network. In this regard, it may be concluded that the fracturing treatment was ineffective or may be concluded that a more extensive naturally occurring fracture system existed than initially assumed.

In accordance with some embodiments of the invention, a calibration well may be used to verify the model parameters and balance the calculated and actual volumes. Subsequent differences in the calculated and actual fluid volumes may be used to evaluate the effectiveness of the hydraulic fracture treatment and quantify the productivity of the well 10.

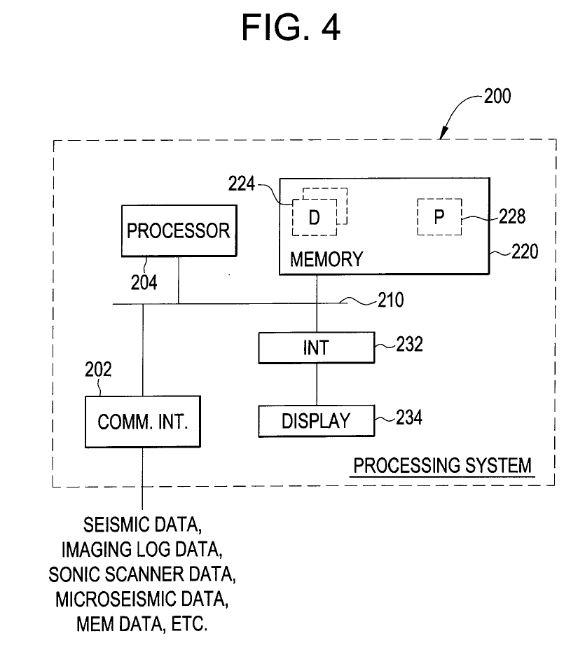

Referring to FIG. 4, in accordance with some embodiments of the invention, a data processing system 200 may be used to process acquired borehole survey measurement data, seismic measurement data, microseismic measurement data, MEM-derived data, etc., for purposes of performing one or more of the techniques 50 and 100. In this regard, the data processing system 200 may include a processor 204 (one or more central processing units (CPUs), CPU cores, etc.), which is connected by a network architecture 210 to a system memory 220. The system memory 220 may, for example, store various preliminary, intermediate and final datasets 224, which are associated with the techniques 50 and 100. Additionally, for purposes of processing the data pursuant to the techniques 50 and 100, the processor 204 may execute program instructions 228 that are stored in the memory 220.

Additionally, as depicted in FIG. 4, the data processing system 200 may include a communication interface 202 (a network interface, for example), which receives the various data mentioned above, such as seismic measurement data, imaging log data, sonic scanner measurement data, microseismic measurement data, MEM data, etc. Furthermore, in accordance with some embodiments of the invention, the data processing system 200 may include a display 234 that is coupled to the communication bus architecture 210 by an interface 232 for purposes of displaying preliminary, intermediate or final processing results associated with the techniques 50 and 100. For example, in accordance with some embodiments of the invention, the display 234 may display the naturally occurring fracture system and may display the fracture system as indicated by the DFN model. Other variations are contemplated and are within the scope of the appended claims.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising:
identifying naturally occurring fractures in a reservoir associated with a well; and
generating a fracture network model to characterize a fracture system in the well, comprising constraining the fracture network model based at least in part on microseismic measurements acquired during a fracturing operation conducted in the well and the identified naturally occurring fractures.

2. The method of claim 1, wherein the act of constraining comprises constraining the extent and density of a fracture system indicated by the model.

3. The method of claim 1, wherein the act of constraining is further based at least in part on locations of the identified naturally occurring fractures.

4. The method of claim 1, wherein the act of identifying comprises processing measurements acquired by a seismic survey and/or a borehole survey.

5. The method of claim 1, further comprising:
further constraining fracture properties of the fracture network model based at least in part on a mechanical earth model of the reservoir.

6. The method of claim 5, wherein the fracture properties comprise fracture widths and fracture heights.

7. The method of claim 5, wherein the mechanical earth model indicates whether the fractures are open or closed.

8. The method of claim 1, further comprising:
based on the fracture network model, calculating a fracture volume;
comparing a fluid volume injected during the fracturing operation to the calculated volume; and
quantifying information about the reservoir based on the comparison.

9. The method of claim 8, wherein the act of quantifying comprises at least one of quantifying information about production and quantifying information about the effectiveness of the fracturing operation.

10. A system comprising:
an interface to receive first data indicative of identified naturally occurring fractures in a reservoir that is associated with a well and second data indicative of microseismic measurements acquired during a fracturing operation conducted in the well; and
a processor to generate a fracture network model and constrain the model based at least in part on the first and second data.

11. The system of claim 10, wherein the processor is further adapted to constrain the fracture network model based at least in part on the locations of the identified naturally occurring fractures.

12. The system of claim 10, wherein the processor is further adapted to constrain fracture properties of the fracture network model based at least in part on a mechanical earth model of the reservoir.

13. The system of claim 10, wherein the processor is further adapted to calculate a volume based on the discrete fracture network and generate an indication of the comparison of a fluid volume injected during the fracturing operation and the calculated volume.

14. An article comprising a computer readable storage medium storing instructions that when executed cause a computer to:
receive first data indicative of naturally occurring fractures in a reservoir associated with a well;
receive second data indicative of microseismic measurements acquired during a fracturing operation in the well;
generate a fracture network model; and
constrain the fracture network model based at least in part on the first and second data.

15. The article of claim 14, the storage medium storing instructions that when executed by the computer cause the computer to constrain the fracture network model based at least in part on the locations of the identified naturally occurring fractures.

16. The article of claim 14, the storage medium storing instructions that when executed by the computer cause the computer to constrain fracture properties of the fracture network model based at least in part on a mechanical earth model of the reservoir.

17. The article of claim 14, the storage medium storing instructions that when executed by the computer cause the computer to calculate a volume based on the discrete fracture network and generate an indication of the comparison of a fluid volume injected during the fracturing operation and the calculated volume.
